(19) United States
(12) Patent Application Publication
(10) Pub. No.: US 2012/0056826 A1
(43) Pub. Date: Mar. 8, 2012

(54) TOUCH SCREEN PANEL DISPLAY

(75) Inventors: Kyung Min KIM, Suwon-si (KR); Jae Wook RHEEM, Hwaseong-si (KR); Kwang Seok JANG, Suwon-si (KR); Hyung Gwang KANG, Suwon-si (KR); Ok Kyung LEE, Namyangju-si (KR)

(73) Assignee: SAMSUNG ELECTRONICS CO. LTD., Suwon-si (KR)

(21) Appl. No.: 13/079,176

(22) Filed: Apr. 4, 2011

(30) Foreign Application Priority Data
Sep. 8, 2010 (KR) 10-2010-0087731

(51) Int. Cl. G06F 3/041

(52) U.S. Cl. 345/173

(57) ABSTRACT

A touch screen panel display for effectively transmitting vibration force is disclosed. The touch screen panel display includes a display comprising a vibrator, a touch screen panel, an upper case, an inelastic layer disposed between and attaching the display and the touch screen panel, and an elastic layer disposed between and attaching the upper case and the touch screen panel. Vibration force may be prevented from being transmitted from the vibrator of the display to the upper case, so that a user touching the touch screen may get effective feedback vibration.

### PRIORITY

This application claims the benefit under 35 U.S.C. §119(a) of a Korean patent application filed on Sep. 8, 2010 in the Korean Intellectual Property Office and assigned Serial No. 10-2010-0087731, the entire disclosure of which is hereby incorporated by reference.

### BACKGROUND OF THE INVENTION

1. Field of the Invention

The present invention relates to a touch screen panel display. More particularly, the present invention relates to a touch screen panel display in which a vibration force is effectively transmitted using a piezoelectric vibrator.

2. Description of the Related Art

Recently, in order to reduce the weight and thickness of a mobile terminal and to increase the area of a display thereof, a touch screen panel display has been widely employed in the mobile terminal. With such a feature, a user touches the upper surface of the touch screen panel with a finger for, for example, the selection of a menu or the input of numbers. More recently, technology of enabling a user to feel a vibration has been applied to the touch screen panel display such that a user may thereby more accurately make the touch input. The touch screen panel display according to the related art will be described with reference to FIG. 1 as follows.

FIG. 1 is a sectional view illustrating a cross section of a touch screen panel display according to the related art.

Referring to FIG. 1, a touch screen panel display 100 includes a display 110 having a piezoelectric vibrator 111, a touch screen panel 120, and an upper case 130. The upper side of an inelastic double-sided adhesive tape 140 is attached to the lower side of the edge of the touch screen panel 120. Some portion of the lower side of the inelastic double-sided tape 140 is attached to the upper edge of the display 110 and the rest of the lower side of the inelastic double-sided adhesive tape 140 is attached to the upper case 130.

In the touch screen panel display 100, since the display 110, the touch screen panel 120, and the upper case 130 are attached to each other by the single inelastic double-sided adhesive tape 140, a vibration force of the piezoelectric vibrator installed in the display 110 is transmitted to the upper case 130 via the touch screen panel 120. However, the vibration force is also distributed to entire mobile terminal so that a user has difficulty sensing a feedback vibration effectively.

### SUMMARY OF THE INVENTION

An aspect of the present invention is to address at least the above-mentioned problem and/or disadvantages and to provide at least the advantages described below. Accordingly, an aspect of the present invention is to provide a touch screen panel display in which a vibration force of a piezoelectric vibrator that is installed in a display is concentrated to a touch screen panel to enable a user touching the touch screen panel to feel an increased and more focused vibration force.

In accordance with an aspect of the present invention, a touch screen panel display is provided. The display includes a display comprising a vibrator, a touch screen panel, an upper case, an inelastic double-sided layer disposed between and in contact with the display and the touch screen panel, and an elastic double-sided layer disposed between the upper case and the touch screen panel.

The touch screen panel display may further include an elastic one-sided tape attached to the lower side of the display.

According to the touch screen panel display, the upper case and the touch screen panel are attached to each other with an elastic double-sided adhesive tape to prevent the vibration force from being transmitted from the piezoelectric vibrator that is installed in the display to the upper case, such that a user touching the touch screen panel may thereby more effectively feel a feedback vibration.

Moreover, an elastic one-sided adhesive tape is attached to the lower side of the display to prevent the vibration force from being transmitted from the piezoelectric vibrator to a bracket disposed under the display.

In accordance with another aspect of the present invention, a touch screen panel display is provided. The touch screen panel display includes a display, a vibrator for generating a vibration force, a touch screen panel, a case, inelastic means for attaching the vibrator to the display and for transmitting the vibration force thereto, inelastic means for attaching the display to the touch screen panel and for transmitting the vibration force thereto, and elastic means for attaching the touch screen panel to the case and for suppressing a transmission of the vibration force thereto.

The vibrator of the display is not in contact with the case.

In accordance with yet another aspect of the present invention, a method of improving a vibration feedback of a touch screen panel display is provided. The method includes generating a vibration force, transmitting the vibration force to a touch screen panel, and suppressing a transmission of the vibration force from the touch screen panel to a case structure.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a sectional view illustrating a touch screen panel display according to the related art;

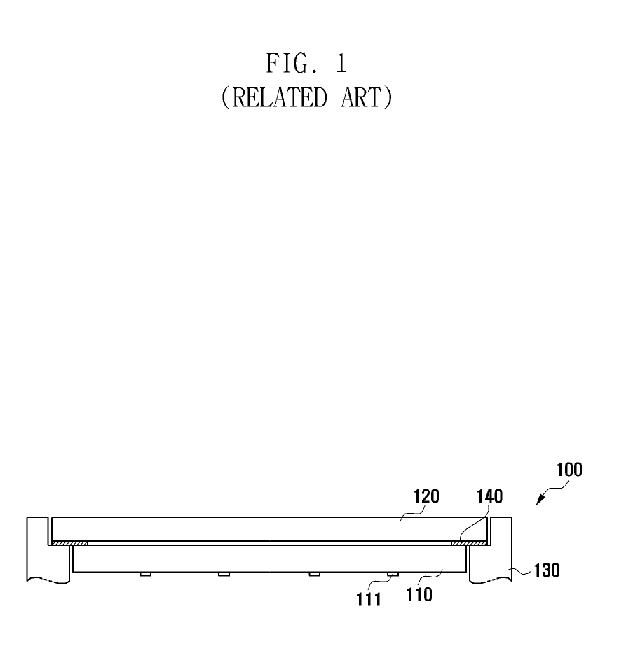

FIG. 2 is a plan view illustrating a touch screen panel display according to an exemplary embodiment of the present invention;

FIG. 3 is a sectional view taken along the line A-A′ of FIG. 2 according to an exemplary embodiment of the present invention; and

FIG. 4 is a bottom view of the touch screen panel display of FIG. 3 according to an exemplary embodiment of the present invention; and

FIG. 5 is a bottom view of the display of FIG. 3 according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

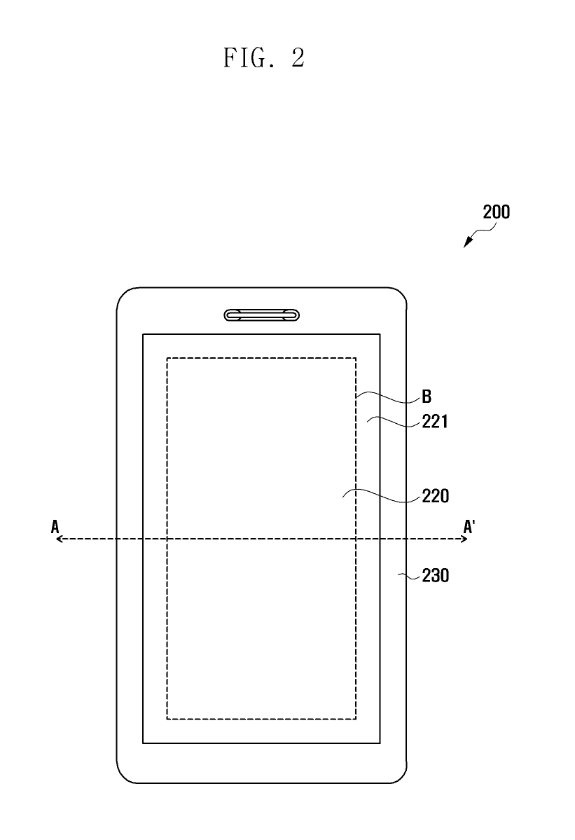

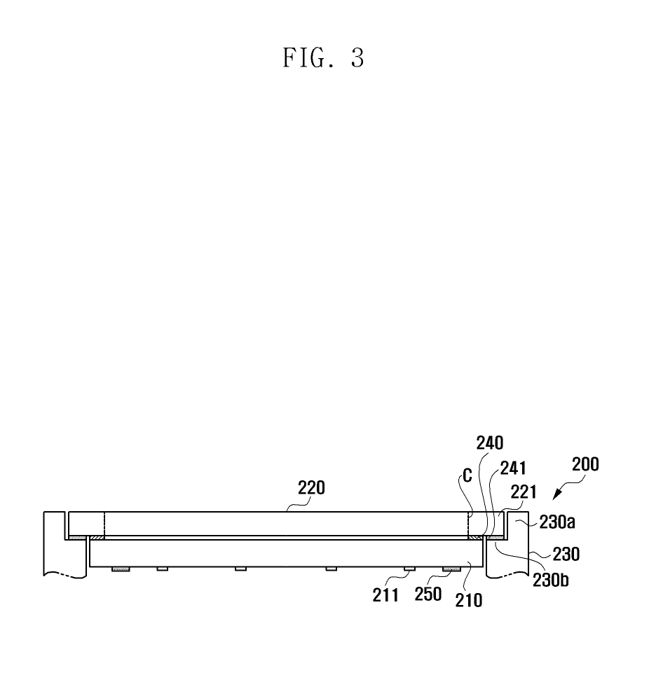

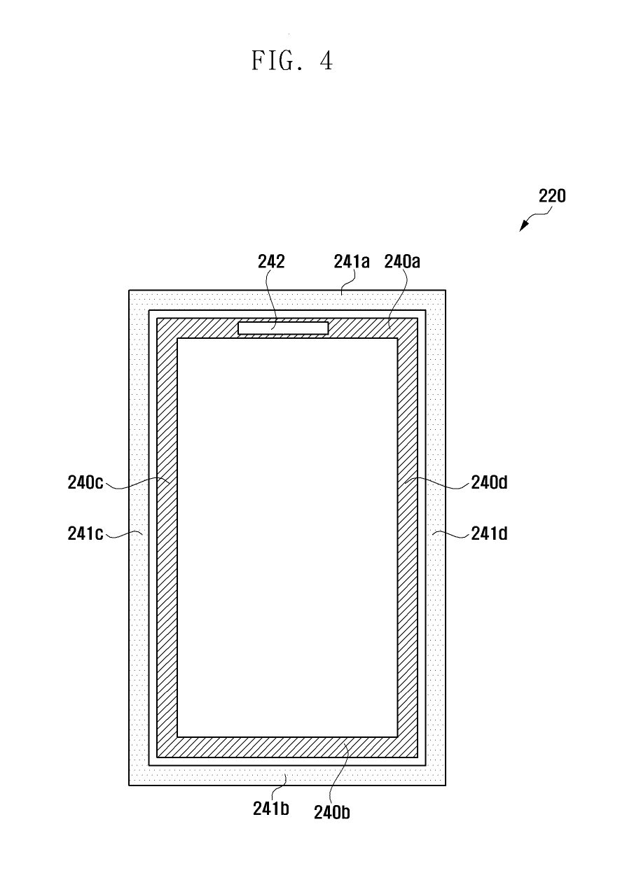

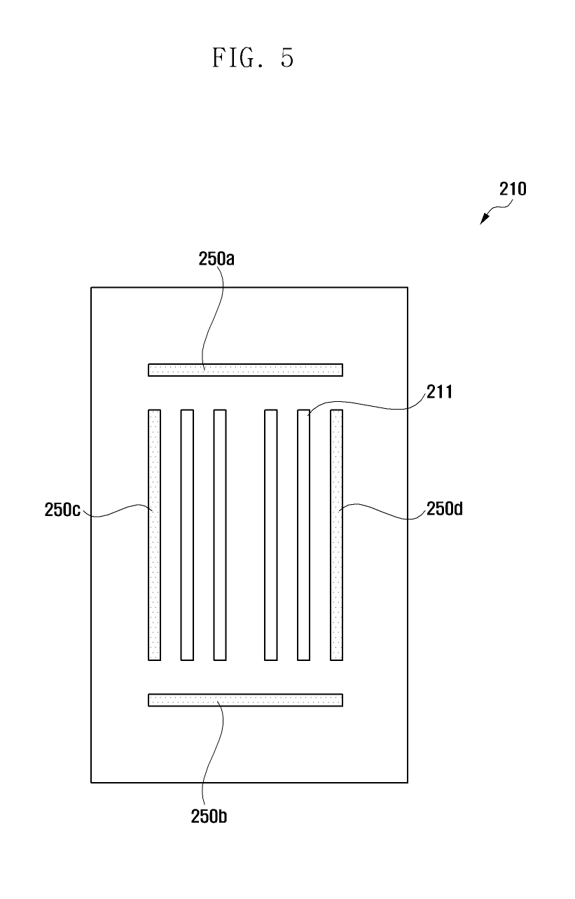

FIG. 2 is a plan view illustrating a touch screen panel display according to an exemplary embodiment of the present invention. FIG. 3 is a sectional view taken along the line A-A′ of FIG. 2 according to an exemplary embodiment of the present invention. FIG. 4 is a bottom view of the touch screen panel display of FIG. 3 according to an exemplary embodiment of the present invention. FIG. 5 is a bottom view of the display of FIG. 3 according to an exemplary embodiment of the present invention.

Referring to FIGS. 2 to 5, a touch screen panel display 200 according to an exemplary embodiment of the present invention includes a display 210, a touch screen panel 220, and an upper case 230.

The display 210 is an element displaying an image, such as a Liquid Crystal Display (LCD). On the lower side of the display 210, a piezoelectric vibrator 211 is installed to transmit feedback vibration to a user when the user touches the touch screen panel 220. In this exemplary embodiment, as illustrated in FIG. 5, four bar-type piezoelectric vibrators 211 are provided, but the shape and number of the piezoelectric vibrators 211 are not limited thereto.

Moreover, an elastic one-sided tape 250 is attached to the lower side of the display 210 so as to suppress a transmission of the vibration force of the piezoelectric vibrators 211 to a bracket (not shown) disposed on the lower side of the display 210. The elastic one-sided tape 250 has an adhesive upper side that is coated with adhesive and that is attached to the display 210 and a non-adhesive lower side that is not coated with adhesive. The elastic one-sided tape 250 may be made of silicon rubber. The elastic one-sided tape 250 may be thicker than the thickness of the piezoelectric vibrators 211 in order to prevent the piezoelectric vibrator 211 from coming in contact with the bracket. In this exemplary embodiment, as illustrated in FIG. 5, the elastic one-sided tape 250 has a top side 250a, a bottom side 250b, a left side 250c, and a right side 250d, that may be separated from each other or connected to each other.

The touch screen panel 220 is a device enabling a user to input a desired item by touching an image displayed on the display 210. The touch screen panel 220 is laminated on the display 210. The edge 221 (the regions of the touch screen panel 220 outside the dotted line B of FIG. 2 and the dotted line C of FIG. 3) of the touch screen panel 220 protrudes over the lateral upper sides of the display 210. For reference, in FIG. 2, the edge 221 of the touch screen panel 220 includes a black region in which no image is displayed, and a region of the touch screen panel 220 inside of the dotted line B becomes a region in which an image is displayed.

The upper case 230 supports the touch screen panel 220 and includes a sidewall 230a and a support 230b. The sidewall 230a protects the lateral sides of the touch screen panel 220 and is formed along the lateral sides of the touch screen panel 220. The support 230b supports the touch screen panel 220 and is positioned under the edge 221 of the touch screen panel 220.

An inelastic double-sided adhesive tape 240 is disposed between the upper side of the edge of the display 210 and the lower side of the edge 221 of the touch screen panel 220. The inelastic double-sided adhesive tape 240 attaches the display 210 to the touch screen panel 220 and transmits the vibration force of the piezoelectric vibrator 211 to the touch screen panel 220. As illustrated in FIG. 4, the inelastic double-sided adhesive tape 240 may have a structure in which a top 240a, a bottom 240b, a left side 240c and a right side 240d are interconnected. In this exemplary embodiment, an opening 242 in which a display driver Integrated Circuit (IC) (not shown) is to be seated is formed in the middle of the top 240a of the inelastic double-sided adhesive tape 240. The inelastic double-sided adhesive tape 240 may be made of acryl.

An elastic double-sided adhesive tape 241 is disposed the upper side of the support 230b of the upper case 230 and the lower side of the edge 221 of the touch screen panel 220. The elastic double-sided adhesive tape 241 attaches the touch screen panel 220 to the upper case 230 and prevents the vibration force from being transmitted from the piezoelectric vibrator 211 to the upper case 230 via the touch screen panel 220. As illustrated in FIG. 4, the elastic double-sided adhesive tape 241 of this exemplary embodiment may have a structure in which a top 241a, a bottom 241b, a left side 241c, and a right side 241d are interconnected. The elastic double-sided adhesive tape 241 is positioned outside of the inelastic double-sided adhesive tape 240 by a predetermined distance and may be made of silicon rubber.

According to this exemplary embodiment, since the elastic double-sided adhesive tape 241 is disposed between the upper side of the support 230b of the upper case 230 and the lower side of the edge 221 of the touch screen panel 220, the transmission of the vibration force from the piezoelectric vibrator 211 to the upper case 230 via the touch screen panel 220 is suppressed and the vibration force may be concentrated to the touch screen panel 220. Thus, a user touching the touchscreen may get faster and more focused vibration feedback. Moreover, since the elastic one-sided tape 250 is attached to the lower side of the display 210, the transmission of the vibration force from the piezoelectric vibrator 211 to a lower bracket of the display 210 may be prevented.

While the invention has been shown and described with reference to certain exemplary embodiments thereof, it will be understood by those skilled in the art that various changes in form and details may be made therein without departing from the spirit of the invention as defined by the appended claims and their equivalents.

What is claimed is:

1. A touch screen panel display comprising:
a display comprising a vibrator;
a touch screen panel;
an upper case;
an inelastic layer disposed between and in contact with the display and the touch screen panel; and
an elastic layer disposed between and in contact with the upper case and the touch screen panel.

2. The touch screen panel display of claim 1, wherein the inelastic and elastic layers comprise double-sided adhesive tape.

3. The touch screen panel display of claim 2, wherein the inelastic double-sided adhesive tape comprises acryl.

4. The touch screen panel display of claim 2, wherein the elastic double-sided adhesive tape comprises silicon rubber.

5. The touch screen panel display of claim 1, further comprising an elastic one-sided tape attached to a lower side of the display.

6. The touch screen panel display of claim 5, wherein the elastic one-sided tape is thicker than the vibrator.

7. The touch screen panel display of claim 1, wherein the elastic layer is spaced apart from the inelastic layer by a predetermined distance.

8. The touch screen panel display of claim 1, wherein the inelastic layer is disposed between an upper side of an edge of the display and a lower side of an edge of the touch screen panel.

9. The touch screen panel display of claim 1, wherein the elastic layer is disposed between an upper side of a support of the upper case and a lower side of an edge of the touch screen panel.

10. The touch screen panel display of claim 1, wherein the vibrator comprises a piezoelectric vibrator.

11. The touch screen panel display of claim 1, wherein the vibrator comprises a plurality of vibrator elements.

12. A touch screen panel display comprising:
a display;
a vibrator for generating a vibration force;
a touch screen panel;
a case;
inelastic means for attaching the vibrator to the display and for transmitting the vibration force thereto;
inelastic means for attaching the display to the touch screen panel and for transmitting the vibration force thereto; and
elastic means for attaching the touch screen panel to the case and for suppressing a transmission of the vibration force thereto.

13. The touch screen panel display of claim 12, wherein the vibrator attached to the display is not in contact with the case.

14. A method for improving a vibration feedback of a touch screen panel display, the method comprising:
generating a vibration force;
transmitting the vibration force to a touch screen panel; and
suppressing a transmission of the vibration force from the touch screen panel to a case structure.
